(19) United States
(12) Patent Application Publication
(10) Pub. No.: US 2009/0205335 A1
(43) Pub. Date: Aug. 20, 2009

(54) DOMESTIC ENERGY SUPPLY SYSTEM

(76) Inventor: Karl Wohlleib, Erolzheim (DE)

Correspondence Address: LERNER GREENBERG STEMER LLP, P O BOX 2480, HOLLYWOOD, FL, 33022-2480, US

(21) Appl. No.: 12/438,989

(22) PCT Filed: Aug. 23, 2007
(86) PCT No.: PCT/DE2007/001508

§ 371 Date: Feb. 26, 2009

(30) Foreign Application Priority Data
Aug. 26, 2006 (DE) 10 2006 040 147.6

(51) Int. Cl. F03G 7/00; F03G 6/00; F01K 3/08; F02B 65/00

(52) U.S. Cl. 60/641.2; 60/641.8; 60/659; 123/2

(57) ABSTRACT

In a domestic energy supply system, the thermal energy of the temperature difference between at least one heat source and at least one heat sink is converted into work by way of a thermal engine. The thermal engine has a fluid cycle with at least two reservoirs, which, in each case as a condenser to be cooled or an evaporator to be heated, are thermally coupled to the heat source or the heat sink. A working temperature difference between the reservoirs of approximately 10° to 200° C. is set at a working temperature of 30° to 280° C. The thermal engine has a hybrid motor in the form of a combination of a pressure media motor and an internal combustion engine, in which firstly a pressure difference of the fluid as a result of the working temperature difference is used for driving purposes and secondly fuel is combusted and converted into work. Furthermore, the invention relates to a method for controlling such a system.

The invention pertains to a domestic energy supply system, particularly for supplying a house and/or a vehicle with power and/or heat and/or compressed air.

In order to save energy and to conserve resources, it is desirable to achieve the highest energy efficiency possible for a house.

WO 2004 005676 A1 discloses a thermal power plant, in which a temperature difference between a heat source and a heat sink is utilized, wherein an internal closed circuit is provided that features at least two heat exchangers that are connected into a circuit, through which a medium can circulate that is able, in particular, to absorb thermal energy, wherein the heat exchangers respectively can be externally cooled or heated in the interior such that they can selectively operate as an evaporator or as a condenser for the medium circulating therein, wherein the heat source and the heat sink can be respectively assigned to either a first heat exchanger or a second heat exchanger, and wherein the medium is transported from one heat exchanger to the other heat exchanger due to the temperature difference of the heat exchangers caused by the heat source and the heat sink.

The invention is based on the objective of making available a domestic energy supply system, in which optimized energy efficiency can be achieved, wherein the constructive design allows, in particular, a multiple utilization of the usable energies in comparison with the state of the art.

This objective is attained with a domestic energy supply system according to the characteristics of claim 1 and a method for operating such a domestic energy supply system according to claim 11.

The invention proposes a domestic energy supply system for supplying a house and/or a vehicle with power and/or heat and/or compressed air, wherein at least one of the following thermal energy sources is provided:
sunlight,
hot water from a heating water or hot water circuit of an existing oil-fired, pellet-fired or gas-fired heating installation or a small-scale power plant,
district heat,
   waste heat of devices that generate lost heat, particularly a fuel cell and/or an existing oil-fired, pellet-fired or gas-fired heating installation,
geothermal heat or a geothermal heat accumulator,
   wherein at least one of the following heat sinks is provided:
the soil and/or
the outside air and/or
a flowing or standing body of water and/or
the hot water flow pipe or heating installation flow pipe of the heating or hot water circuit of the existing oil-fired, pellet-fired or gas-fired heating installation and/or
a heat accumulator,
   wherein the thermal energy of the temperature difference between the heat source and the heat sink is converted into work by means of a thermal engine, wherein the thermal engine features a fluid circuit with at least two reservoirs that respectively are thermally coupled to the heat source or the heat sink in the form of a condenser to be cooled or an evaporator to be heated, wherein a working temperature difference between the reservoirs of approximately 10° to 200° is adjusted at a working temperature of 30° to 280° C., and wherein the thermal engine features a hybrid engine in the form of a combination of a pressure medium engine and an internal combustion engine, in which a pressure difference of the fluid resulting from the working temperature difference is used for driving purposes and fuel is combusted and converted into work.

According to the invention, the hybrid engine is exclusively provided in the form of a pressure medium engine in a domestic energy supply system in combination or in cooperation with a small-scale power plant.

The invention makes it possible to realize a domestic energy supply system, for example, in the form of a solar block heating installation that can be operated with different types of energy and provides different types of energy.

In the pressure medium engine, the pressure difference between the reservoirs that respectively operate as an evaporator and as a condenser is preferably converted into mechanical work.

According to one equally preferred embodiment of the invention, it is proposed that compressed air stored in a compressed air tank provided for this purpose is used for driving purposes in the pressure medium engine.

According to one additional development of the invention, a heat accumulator is provided, particularly a water tank, wherein the heat accumulator can be used as a heat sink or as a heat source by means of a switchable thermal coupling with the reservoirs provided for this purpose.

It is advantageous to provide the heat accumulator with another switchable thermal coupling, by means of which the heat accumulator can be connected to and heated by one of the heat sources.

The fluid advantageously consists of perfluoropentane or a mixture of perfluoropentane and propane or a mixture of water and ammonia. It would also be possible to use other substances with similar properties.

The mixture can preferably be adjusted in dependence on the desired working temperature, wherein the mixing ratio is metered and varied by a mixing device.

According to one particularly preferred additional development of the invention, it is proposed that a power generator is provided, on which the thermal engine performs work.

It is advantageous to provide an air compressor, on which the thermal engine performs work.

According to one embodiment of the invention, it is therefore proposed that the air compressor is provided for filling the compressed air tank, the compressed air of which is used for operating the hybrid engine or for driving a vehicle.

It is advantageous to provide a control that calculates an optimal interconnection between the heat sinks, the heat sources and the reservoirs based on the current temperatures therein.

According to another aspect of the invention, a method is proposed for operating a domestic energy supply system according to one of Claims 1 to 10, wherein said method is characterized by the following steps:
measuring the current temperatures in the heat sinks, the heat sources, the heat accumulator and the reservoirs,
selecting a heat source for the process management that is as hot as possible based on the measured temperatures, wherein solar heat is preferred as the heat source, and
utilizing the heat accumulator either for the process management with a heat source in the form of a drifting heat sink or for the process management with a heat sink in the form of a drifting heat source, wherein a process management is preferred, in which the heat accumulator is initially heated.

Since the heat accumulator can be used as a heat source or as a heat sink by heating or cooling the heat accumulator, it is possible to achieve an optimal process management in a thermal engine without losing valuable thermal energy of a currently hot heat source. In this case, the colder heat accumulator is connected in the form of a heat sink. Once the heat source cools off again such as, for example, at night, the heat accumulator itself is used as heat source.

According to one variation of the method, the heat supplied to the thermal engine preferably consists primarily of solar heat.

According to another variation of the method, the heat supplied to the thermal engine consists, if no solar heat is available, of geothermal heat or heat from a geothermal heat accumulator in an alternative embodiment of the invention.

In another equally preferred alternative of the method, it is proposed that the provided compressed air tank is used for driving the hybrid engine and therefore for generating power if no solar heat is available and no heating is required in the house.

If no solar heat is available, no heating is required in the house and the compressed air tank is depleted, the hybrid engine is operated with fuel in order to generate power according to one advantageous process step.

If no solar heat is available during the normal seasonal heating period, it is advantageously possible to use the heating installation flow pipe as heat source.

Consequently, it would be possible to use a conventional heating installation return pipe as a heat sink.

When operating the thermal engine with solar heat, the soil is advantageously chosen as the heat sink.

The waste heat of the hybrid engine produced when the hybrid engine is operated with a fuel is advantageously stored in the heat accumulator.

In one particularly preferred variation of the method, it is proposed that the heat accumulator is used as heat source after a predetermined maximum temperature is reached therein.

The invention is described in greater detail below with reference to the drawing. In this schematic drawing:

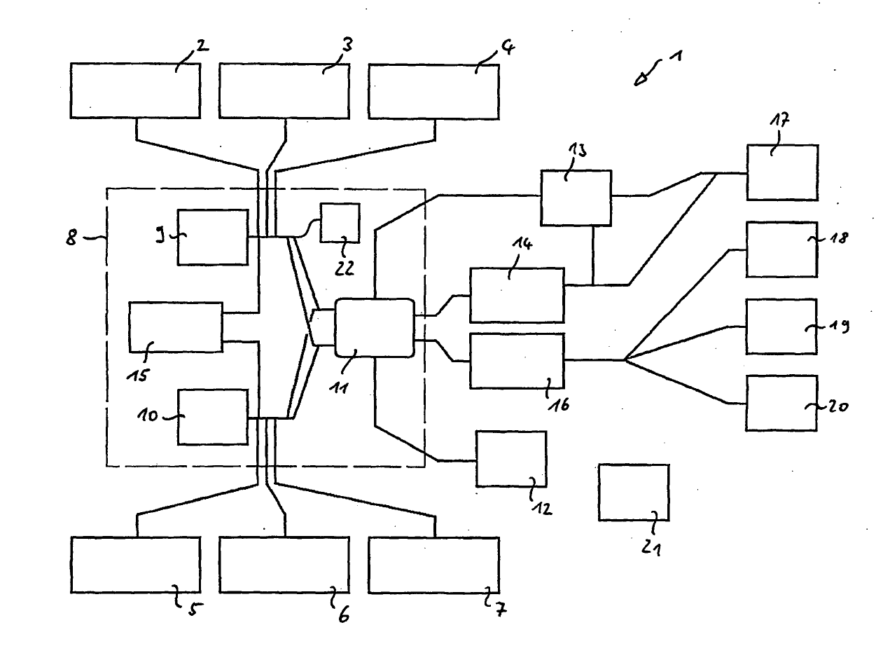

FIG. 1 shows a schematic block diagram of an inventive domestic energy supply system.

The only FIG. 1 shows the schematic design of a domestic energy supply system 1 for supplying a house or a vehicle with power and compressed air.

A thermal engine is connected between different thermal energy sources 2 (solar heat), 3 (geothermal heat) and 4 (domestic heating installation) and heat sinks 5, 6 (soil) and 7 (heating installation return pipe).

In this case, the thermal energy of the temperature difference between one respective connected heat source (2, 3 or 4) and one respective heat sink (5, 6 or 7) is converted into work by the thermal engine 8.

For this purpose, the thermal engine features a fluid circuit with two reservoirs 9 and 10 that can be thermally coupled to the respectively selected heat source or heat sink in the form of a condenser to be cooled or an evaporator to be heated, respectively. The fluid may consist, for example, of perfluoropentane or a mixture of perfluoropentane and propane or a mixture of water and ammonia. In the example shown, a mixing control 22 is also provided in order to make it possible to adapt the process temperatures of the thermal engine, wherein the mixture of the fluid circulating between the reservoirs can be adjusted by means of said mixing control in dependence on the desired working temperature, and wherein the mixing ratio is metered and varied by the mixing control.

The working temperature difference between the reservoirs is adjusted to approximately 10° to 200° at a working temperature of 30° to 280° C.

In order to perform work, a hybrid engine 11 in the form of a combination of a pressure medium engine and an internal combustion engine is provided in the thermal engine. This not only makes it possible to use a pressure difference of the fluid resulting from the working temperature difference for driving purposes, but also to combust and convert fuel into work in case the temperature differences between the heat sinks and the heat sources occasionally do not suffice. In the pressure medium engine, the pressure difference between the respective reservoirs 9 and 10 that are connected in the form of an evaporator and a condenser is converted into mechanical work.

Consequently, the driving energy for the domestic energy supply system 1 may consist of various types of thermal energy (sun, geothermal heat, waste heat of fuel cells, waste heat of power plants, district heat, geothermal heat accumulator, . . . ) that are respectively available as heat sources. However, it is also possible to use all types of fuels such as, for example, fuel from a fuel tank 12, as well as pressure energy produced by pressurized gaseous substances from a compressed air tank 13. It is also possible to utilize electric energy.

A heat accumulator 15 in the form of a water tank is provided, wherein the heat accumulator can be used as a heat sink or as a heat source by means of a switchable thermal coupling with the reservoirs 9, 10 provided for this purpose, namely depending on the current temperature of the medium in the heat accumulator. A switchable thermal coupling of the heat accumulator 15 makes it possible to connect the heat accumulator to one of the heat sources in order to be heated separately of the process if one of the heat sources has an excess temperature that is currently not used for the thermal engine.

A control 17 is provided that calculates an optimal interconnection between the heat sinks 5, 6, 7, the heat sources 2, 3, 4, the heat accumulator 15 and the reservoirs 9, 10 based on the current temperatures therein and adjusts this interconnection by connecting and disconnecting the components accordingly.

Electric energy, thermal energy, as well as pressure energy (pressurized gaseous substances), can be produced in the domestic energy supply system. For this purpose, a power generator 16 that is coupled to the hybrid engine and an air compressor 14 are provided, on which the thermal engine 8 performs work depending on the respective requirements. If no electric energy is required, a compressed air tank 13 is filled.

For example, the following consumers may be connected to the domestic energy supply system: a vehicle 17 that is fueled with compressed air in order to drive its engine, a vehicle 18 that is charged with electric energy in order to drive an electric engine, as well as other electric consumers 19 and 20 in or on the house.

The domestic energy supply system is designed in such a way that it is adapted to the different seasons (spring, summer, fall and winter) and to the daily energy conditions (environment, atmospheric conditions, temperature, sun, wind, clouds, . . . ) and operates with different operational modifications with respect to the heat source and heat sink to be used or the selection of the type of energy used by producing the corresponding connection with the aid of a control 21.

The control 21 and, if applicable, the mixing control 22 for mixing the easily evaporable substance mixture make it possible to take into account the different daily energy conditions, the outside temperature, the current operating mode and other eventualities during the mixing process of easily evaporable substance mixtures.

This control determines the ideal evaporation temperature of the substance mixture for the cyclic steam generation process based on the measurable and known parameters.

The mixing ratio can be calculated anew prior to each evaporation cycle and optimized in accordance with the environmental conditions.

Solar thermal energy is abundantly available during the summer months with an insolation surface of approximately 1 kW/m². This thermal energy that was frequently not utilized until now is used for generating power or compressed air. These types of energy can then be stored for use in the residence or the motor vehicle or used for supplying power.

An improved temperature potential for the evaporation process and/or the utilization for interseasonal heating can be realized with a geothermal heat probe, particularly for a heat dissipation depth of approximately 10-100 m.

Part of the heat can also be stored in accumulators, for example, geothermal heat accumulators or water tanks, or supplied in the form of geothermal heat.

If the domestic energy supply system is used, e.g., in single-family houses or multi-family dwellings, for example, with systems for supplying motor vehicle driving energy or with a feed into the electrical or heating network, the size of the respectively required pressure medium engine/generator is adapted to the maximum energy demand, as well as to the usable solar insolation surface.

The invention makes it possible to eliminate a domestic connection to the public electric grid or can also be used for selling excess power. Furthermore, part of the energy produced in the domestic energy supply system (power/compressed air) can be at least intermittently used for motor vehicles (e.g., in automobiles with hybrid drives) or other purposes.

### A: Summer Mode

During the summer months and during all periods of sunshine, the domestic energy supply system is primarily driven with solar thermal energy.

In this case, an easily evaporable substance mixture (e.g., perfluoropentane/alcohol) that was pre-mixed by the “mixing device” in accordance with the external energy conditions and the operating mode is heated, evaporated and superheated in a cyclic fashion with the aid of an evaporator.

The vapor mixture is then converted into electric energy/compressed air and into heat in a cyclic fashion in accordance with known methods, e.g., by means of a hybrid pressure medium engine (hybrid drive with fuels and/or pressure mediums) with a steam turbine or the like.

The electric energy is generated with the aid of a generator that is coupled to the hybrid pressure medium engine and the optional compressed air is generated with the aid of a coupled compressor.

The expanded vapor mixture subsequently reaches the condenser that operates in a cyclic fashion.

The “mixing control” separates the “first” condensate mixture, as well as the “last” condensate mixture, after the cooling process in the condenser into auxiliary containers. This condensate has a relatively high content of the lightest volatile substance of the substance mixture in the first container and a very low content of the light volatile substance mixture in the second container.

After the completion of the cyclic evaporation process, the “mixing control” adjusts the mixing ratio of the current evaporation mixture based on the current operating mode, the energy conditions (demands and supplies) and the outside temperature (water temperature). Prior to each cycle, a defined portion of the “first” or the “last” condensate mixture is added to the liquid to be evaporated in the evaporator in order to reach the ideal evaporation temperature.

In order to operate the power plant year-round, it is preferred to utilize a hybrid pressure medium engine that can be operated with pressure mediums (e.g., vapor mixtures of perfluoropentane/alcohol, air) or with fuels (e.g., rapeseed oil); (see, e.g., MDI France patents).

Alternatively, it would also be possible, according to the invention, to replace the internal combustion engine or the domestic heating installation with a gas turbine or a small-scale power plant with a tandem arrangement of a wood gasifier and a Stirling engine such that solid fossil fuels can also be used as energy source.

The superheated vapor mixture from the evaporator is fed to the hybrid pressure medium engine.

After driving the hybrid pressure medium engine, the expanded vapor mixture is condensed by means of cooling water of a geothermal probe/geothermal heat accumulator and/or with the cooled return water of a heating installation (e.g., in a residential house) or with the aid of other mediums/heat accumulators.

Part of the available and generated energy is intermediately stored in pressure medium accumulators, electric accumulators or hot water tanks in order to ensure the energy supply during the nighttime hours and on cloudy days.

In this operating mode, the hybrid pressure medium engine may also drive a coupled air compressor that generates compressed air with very high pressures (e.g., 300 bar), e.g., for driving a motor vehicle.

During the summer months (except on cool days with cloudiness or other access to heat; see above), the domestic energy supply system can be primarily operated with solar thermal energy.

Solar thermal energy makes it possible to accumulate large quantities of thermal energy that, after having been converted into power or compressed air, can also be used outside the residential house, e.g., in a motor vehicle or fed into the electric grid. The relatively large quantity of accumulating condensation heat is dissipated in an environmentally compatible fashion with geothermal probes or into geothermal heat accumulators.

If power/water for domestic use is needed during nighttime hours or cloudiness, the above-described process is carried out with the energy from water tanks, compressed air tanks or electric accumulators, . . . .

If the electric energy required exceeds the incidental quantity of heat required for the power generation, e.g., the solar energy, and the heat accumulators are depleted, the domestic energy supply system switches into the spring/fall operating mode (see below).

### B: Winter Mode

In the winter mode, the domestic energy supply system operates such that the steam generating process is coupled with the heating process or a small-scale power plant.

Heat is supplied by means of a heating burner installation (alternatively solar, geothermal heat, waste heat, district heat, . . . ).

Heat is emitted in the cyclically operating evaporator for evaporating easily evaporable substance mixtures of “current” composition in accordance with the specifications of the “mixing control.”

Electric energy is generated by means of the pressure medium engine/generator and heat is emitted for heating purposes/producing hot water.

Heat is supplied to the heating circuit during the condensation of easily evaporable substance mixtures into the water return pipe of the heating installation.

In addition, the waste heat of the hybrid pressure medium engine/generator is supplied into the return water.

Consequently, the complete waste heat of the evaporation process remains in the heating system.

In this operating mode, water primarily is significantly heated with a conventional heating installation (and supplemental solar heat during sunshine or a supplemental heat accumulator) and then used in the evaporator for the cyclic evaporation of an easily evaporable, freshly mixed substance mixture such as, e.g., perfluoropentane/alcohol.

The generated steam is once again used for generating electric energy by means of the hybrid pressure medium engine/generator. In this case, the waste heat of the hybrid pressure medium engine is returned into the heating system.

The significantly heated water releases thermal energy in the evaporator in order to evaporate, e.g., a perfluoropentane/alcohol mixture and “cools” to the desired flow pipe temperature of the space heating system during this process.

Water with this flow pipe temperature covers the heating water and domestic water demands in the house.

The cooled return water is then used in the condenser for condensing the easily evaporable substance mixture and heated during this process.

In the winter mode, the maximum power/pressure energy generated corresponds to the created waste heat energy required for heating purposes and for producing hot water.

However, at least as much as the current domestic power supply is required.

If the incidental quantity of heat exceeds the heating demand and the heat accumulators are filled, the domestic energy supply system switches into the spring/fall operating mode (see below).

### C: Spring/Fall Mode

In the spring and fall mode, in which only little thermal energy, if any, is required and no or only little solar insolation occurs, the hybrid pressure medium engine is also operated with fuels (e.g., rapeseed oil) as energy source in order to generate power.

The spring/fall operating mode only starts if no energy is any longer available in the accumulators and power is required.

In this case, the hybrid pressure medium engine generates the required electric energy by means of the coupled generator. During this process, large quantities of waste heat are produced that are collected with cooling water and stored in the heat accumulator. This waste heat can be used for flow pipe water of the heating installation and for water for domestic use on demand.

If the heat accumulator is filled, the domestic energy supply system switches into the summer mode and utilizes the thermal energy of the heat accumulator as a source for driving the evaporation process (see summer mode).

If the compressed air tank is also filled, the domestic energy supply system switches into the compressed air mode and supplies the hybrid pressure medium engine with compressed driving air in order to generate power. The compressed air tank is filled, in particular, on mostly sunny and very cold days.

If the domestic energy supply system is used in a very well insulated low-energy house (<11 heating oil/sqm), the winter mode may not be needed at all. This also eliminates the investment costs for a conventional heating installation.

In other words, the thermal energy required for heating purposes and for producing hot water is in this case not greater than the waste heat produced during the generation of power for the household and the motor vehicle by means of the hybrid pressure medium engine.

On very cold winter days, it would also be possible to alternatively heat with electric energy.

An average 4-person household requires approximately 3000 KWh of power annually.

With an efficiency of approximately μ=0.2 during multiple thermal cycling in the above-described fashion, approximately 15,000 KWh of thermal energy are required for generating power during the year.

Solar thermal energy is used for generating power on the approximately 80 days of sunshine.

Approximately 40 KWh of energy are required in the form of pellets, oil, district heating, . . . , on any other day of the year.

The costs for this are currently approximately as high as the costs for purchasing power.

The costs for generating the heat for heating purposes/producing hot water are eliminated because the waste heat of the hybrid pressure medium engine is used for this purpose. Specifically, about 80% of the supplied energy is used for this purpose.

With respect to installation costs, the expenses for power availability fees, meter rent, hook-up fees, . . . , are eliminated.

In well-insulated houses, the costs for the heating installation (burner, heating boiler, . . . ) are also eliminated.

It is estimated that the investment costs for the domestic energy supply system in well insulated houses are no higher than the current costs for the power hook-up and the heating installation.

An economical benefit is achieved on very warm summer days due to the excess production of power, as well as on very cold days, on which the required thermal energy for heating purposes (waste heat) results in a significant power generation.

In other words, the excess electric energy or pressure energy is available, e.g., for use in a motor vehicle; however, this is not the case during the entire year.

It is sensible to utilize an electric-hybrid motor vehicle or a compressed air-hybrid motor vehicle that in part can also be operated with fossil fuels.

### LIST OF REFERENCE SYMBOLS

1 Domestic energy supply system
2 Heat source, solar heat
3 Heat source, geothermal heat
4 Heat source, domestic heating installation
5 Heat sink
6 Heat sink, soil
7 Heat sink, heating installation return pipe
8 Thermal engine
9 Reservoir
10 Reservoir
11 Hybrid engine
12 Fuel tank
13 Compressed air tank
14 Air compressor
15 Heat accumulator
16 Power generator
17 Vehicle
18 Vehicle
19 Consumer
20 Consumer
21 Control
22 Mixing control

1-20. (canceled)

21. A domestic energy supply system, comprising:
at least one thermal energy source selected from the following group:
sunlight;
hot water from a hot water circuit of an existing oil-fired, pellet-fired or gas-fired heating installation or a small-scale power plant;
communal heat or district heat;
waste heat from a lost-heat-generating device;
geothermal heat or a geothermal heat accumulator;
at least one heat sink selected from the following group of heat sinks:
soil;
outside air;
a body of water;
a hot water flow pipe or heating installation flow pipe of the heating or hot water circuit of the existing oil-fired, pellet-fired or gas-fired heating installation; and/or
a heat accumulator;
a thermal engine configured to convert a thermal energy of a temperature difference between the heat source and the heat sink into work, said thermal engine having a fluid circuit with at least two reservoirs that respectively are thermally coupled to the heat source or the heat sink in the form of a condenser to be cooled or an evaporator to be heated, wherein a working temperature difference between the reservoirs of approximately 10° to 200° is adjusted at a working temperature of 30° to 280° C.;
said thermal engine including a hybrid engine in the form of a combination of a pressure medium engine and an internal combustion engine, in which a pressure difference of the fluid resulting from the working temperature difference is used for driving purposes and fuel is combusted and converted into work.

22. The domestic energy supply system according to claim 21, configured for supplying at least one of a house and a vehicle with power and/or heat and/or compressed air.

23. The domestic energy supply system according to claim 21, wherein the lost-heat-generating device is at least one of a fuel cell and an oil-fired, pellet-fired or gas-fired heating installation.

24. The domestic energy supply system according to claim 21, which further comprises a compressed air tank having stored therein compressed air for driving the pressure medium engine.

25. The domestic energy supply system according to claim 21, wherein the energy source is a heat accumulator configured to be selectively used as a heat sink or as a heat source by way of a switchable thermal coupling with the reservoirs.

26. The domestic energy supply system according to claim 25, wherein said heat accumulator is a water tank.

27. The domestic energy supply system according to claim 25, wherein said heat accumulator is provided with further switchable thermal coupling, for connecting said heat accumulator to and heating by one of the heat sources.

28. The domestic energy supply system according to claim 21, wherein the fluid consists of perfluoropentane or a mixture of perfluoropentane and propane or a mixture of water and ammonia.

29. The domestic energy supply system according to claim 28, which further comprises a mixing device for metering a mixing ratio of the mixture and for adjusting the mixture in dependence on the desired working temperature.

30. The domestic energy supply system according to claim 21, which further comprises a power generator, said thermal engine performing work on said power generator.

31. The domestic energy supply system according to claim 21, which further comprises a air compressor, said thermal engine performing work on said air compressor.

32. The domestic energy supply system according to claim 31, wherein said air compressor is connected for filling said compressed air tank, and wherein compressed air is used for operating the hybrid engine or for driving a vehicle fueled with compressed air.

33. The domestic energy supply system according to claim 21, which further comprises a control unit configured to calculate an optimal interconnection between the heat sinks, the heat sources, the heat accumulator and the reservoirs based on currently prevailing temperatures therein and to adjust the interconnection by connecting and disconnecting respective components accordingly.

34. A method for operating a domestic energy supply system, which comprises in the following steps:
providing the energy supply system according to claim 21;
measuring currently prevailing temperatures in the heat sinks, the heat sources, the heat accumulator, and the reservoirs;
selecting a heat source for process management that is as hot as possible based on the measured temperatures, and thereby giving preference to solar heat as the heat source; and
utilizing the heat accumulator either for the process management with a heat source in the form of a drifting heat sink or for the process management with a heat sink in the form of a drifting heat source, and thereby giving preference to a process management in which the heat accumulator is initially heated.

35. The method according to claim 34, which comprises generating the heat for the thermal engine primarily with a solar heat source.

36. The method according to claim 34, which comprises alternatively producing the heat for the thermal engine with a heat source in the form of geothermal heat or heat from a geothermal heat accumulator if no solar heat is available.

37. The method according to claim 34, which comprises driving the hybrid engine with compressed air from the compressed air tank and thereby generating power if no solar heat is available and no heating is required in the domestic system.

38. The method according to claim 34, which comprises operating the hybrid engine with fuel in order to generate power if no solar heat is available, no heating is required in the domestic system, and the compressed air tank is depleted.

39. The method according to claim 34, which comprises using a heating installation flow pipe as the heat source if no solar heat is available and during the heating period.

40. The method according to claim 34, which comprises using a return pipe of a conventional heating installation as a heat sink.

41. The method according to claim 34, which comprises choosing soil as heat sink when the thermal engine is operated with solar heat.

42. The method according to claim 34, which comprises storing waste heat generated by the hybrid engine in the heat accumulator when the hybrid engine is operated with fuel.

43. The method according to claim 34, which comprises utilizing the heat accumulator as an additional heat source after a predetermined maximum temperature is reached therein.
